(19) United States
(12) Patent Application Publication
(10) Pub. No.: US 2025/0240072 A1
(43) Pub. Date: Jul. 24, 2025

(54) COHERENT JOINT TRANSMISSION CSI REPORTING ASSOCIATED WITH FDD

(71) Applicant: InterDigital Patent Holdings, Inc., Wilmington, DE (US)

(72) Inventors: Loic Canonne-Velasquez, Dorval (CA); Afshin Haghighat, Ile-Bizard (CA); Jonghyun Park, Syosset, NY (US); Moon-il Lee, Melville, NY (US)

(73) Assignee: InterDigital Patent Holdings, Inc., Wilmington, DE (US)

(21) Appl. No.: 18/853,263

(22) PCT Filed: Mar. 31, 2023
(86) PCT No.: PCT/US2023/017065

§ 371 Date: Oct. 1, 2024

Related U.S. Application Data
(60) Provisional application No. 63/326,416, filed on Apr. 1, 2022.
(60) Provisional application No. 63/395,390, filed on Aug. 5, 2022.

(51) Int. Cl. H04B 7/06; H04W 24/10; H04W 72/0453

(52) U.S. Cl. CPC H04B 7/0626; H04B 7/0639; H04W 24/10; H04W 72/0453

(57) ABSTRACT

Systems, methods, and instrumentalities are described herein for joint transmission (JT) channel state information (CSI) reporting. Joint transmission CSI may be coherent JT CSI or non-coherent JT CSI. Feedback overhead may be reduced, for example, if reporting CSI for multiple transmission/reception points (TRPs). Precoding matrix indicators (PMIs) and/or co-phasing information for TRPs in JT (e.g., coherent JT or non-coherent JT) may be reported. A wireless transmit/receive unit (WTRU) may be configured to employ operations to reduce feedback overhead and/or report PMIs and/or co-phasing information for TRPs in JT.

### CROSS-REFERENCE TO RELATED APPLICATIONS

The application claims the benefit of U.S. Provisional Application 63/326,416, filed Apr. 1, 2022, and U.S. Provisional Application 63/395,390, filed Aug. 5, 2022, the contents of which are incorporated by reference in their entirety herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein for joint transmission (JT) channel state information (CSI) reporting. Joint transmission CSI may be coherent JT CSI or non-coherent JT CSI. Feedback overhead may be reduced, for example, if reporting CSI for multiple transmission/reception points (TRPs). Precoding matrix indicators (PMIs) and/or co-phasing information for TRPs in JT (e.g., coherent JT or non-coherent JT) may be reported. A wireless transmit/receive unit (WTRU) may employ operations to reduce feedback overhead and/or report PMIs and/or co-phasing information for TRPs in JT.

The WTRU may receive CSI reporting configuration information indicating a set of codebook indices (CIs) and a plurality of TRPs. The CSI reporting configuration information may indicate a number of columns in a matrix (e.g., spatial domain matrix, frequency domain matrix, etc.) that are associated with a (e.g., each) TRP in the plurality of TRPs. The WTRU may determine PMI information for subsets of TRPs from the plurality of TRPs (e.g., where the subsets of TRPs may be determined by the WTRU and/or indicated in the CSI reporting configuration information). The WTRU may determine the PMI information based on receiving and/or measuring RSs (e.g., CSI-RSs) The PMI information may include a channel quality indicator (CQI) value. The WTRU may determine a subset of TRPs (e.g., from multiple subsets of TRPs or the plurality of TRPs), for example, based on the PMI information (e.g., the subset of TRPs with the highest CQI value may be selected). The WTRU may determine that at least two TRPs in the determined subset of TRPs are basis sharing (e.g., in the spatial domain and/or frequency domain), for example, based on the configuration information (e.g., CIs). The WTRU may send a CSI report associated with the selected subset of TRPs. The CSI report may indicate the determined subset of TRPs and the determined PMI information associated with the determined subset of TRPs. The CSI report may include a shared CI associated with the at least two TRPs that are basis sharing, for example, to reduce signaling overhead. The CSI report may include a non-shared CI associated with TRPs in the subset of TRPs that are not basis sharing.

Compression operations may be enhanced, for example, to reduce overhead information. For example, a WTRU may report a basis set (e.g., spatial basis set, frequency basis set, time basis set, etc.) for a coherent JT TRP. The WTRU may report a compressed basis set. The WTRU may be configured to report a compressed basis set shared for multiple coherent JT TRPs. The WTRU may report coefficient sets. The WTRU may report coefficient sets per TRP.

The WTRU may generate a basis matrix, for example, for PMI calculation. The WTRU may generate a basis matrix using basis sets from TRPs (e.g., different associated TRPs).

The WTRU may report CSI. The CSI may comprise CSI components. The WTRU may report different CSI component granularities, such as, for example, a number of bases, a number of coefficients, etc. The WTRU may report different CSI component granularities, for example, for coherent JT TRPs (e.g., different coherent JT TRPs).

The WTRU may report CSI (e.g., PMI) for a TRP. The WTRU may receive an indication indicating a set of TRP pairs. The WTRU may receive configuration information indicating a set of resources associated with CSI reporting. The WTRU may determine CSI for each TRP pair in the set of TRP pairs. The WTRU may determine that the set of resources is below a threshold associated with the set of TRP pairs (e.g., the amount of resources in the set of resources is insufficient to accommodate all TRP pairs). The WTRU may determine a subset of TRP pairs. The subset of TRP pairs may be determined from the set of TRP pairs. The WTRU may perform measurements (e.g., RSRP) on the TRPs in the set of TRP pairs. The WTRU may select TRPs for the subset of TRPs, for example, if the performed measurements for a TRP are above a threshold. The WTRU may send a set of CSI. The WTRU may select CSI reporting contents. For example, the WTRU may select CSI reporting contents as a function of RS groups and/or port groups. The set of CSI may include CSI associated with the TRP pairs in the subset of TRP pairs. For example, the WTRU may report CSI for the subset of TRPs for which it has sufficient resources. In examples, the WTRU may report CSI for a secondary TRP, for example, that is conditioned on a primary TRP's CSI (e.g., PMI).

The WTRU may switch between reporting settings. For example, the WTRU may switch between reporting an aggregated PMI for an aggregated channel (e.g., from coherent JT TRPs) and reporting per TRP PMI and a co-phasing factor.

The WTRU may determine a transmission configuration indicator (TCI), for example, for CSI resources. The TCI may indicate an association between a physical channel (e.g., used for transmission) and a transmission (e.g., reference signal transmission, such as a demodulation reference signal transmission) sent using the physical channel. The WTRU may determine a TCI per port. The WTRU may determine a TCI per port group for CSI resources with multiple port groups.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of joint transmission from multiple TRPs to a WTRU.

FIG. 3 illustrates an example of CSI reporting for multi-TRP CJT.

FIG. 4 illustrates example types of association between TCI states and PGs.

### DETAILED DESCRIPTION

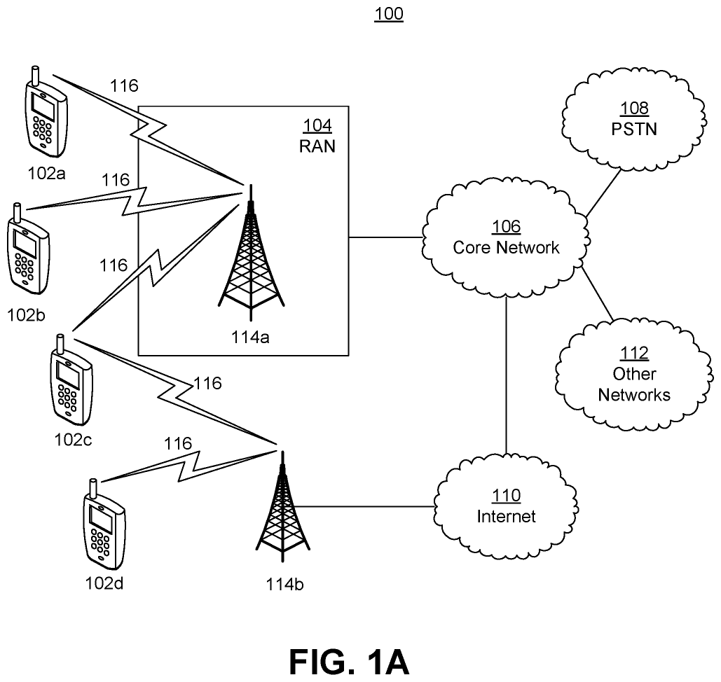

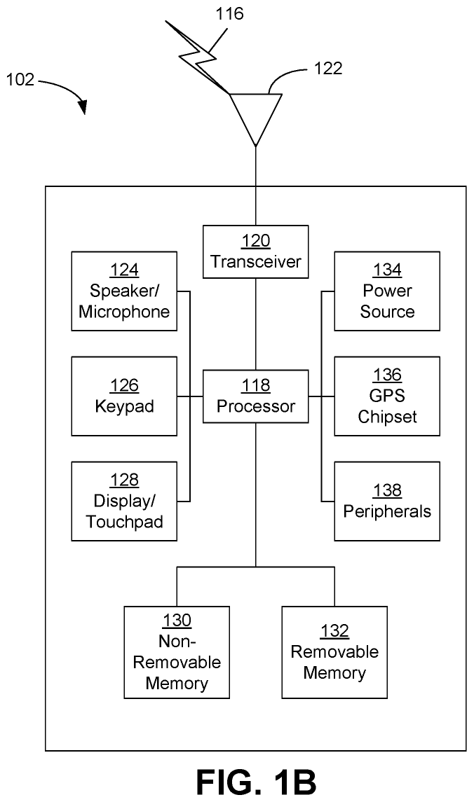

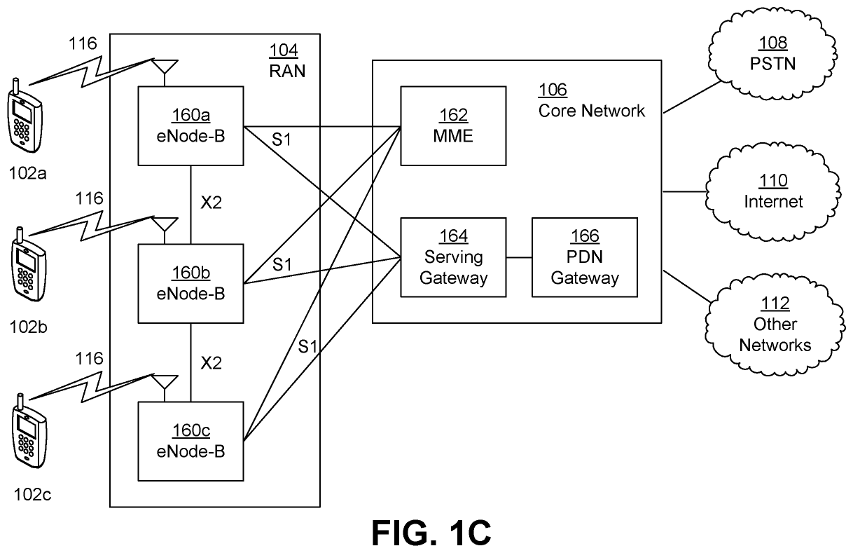

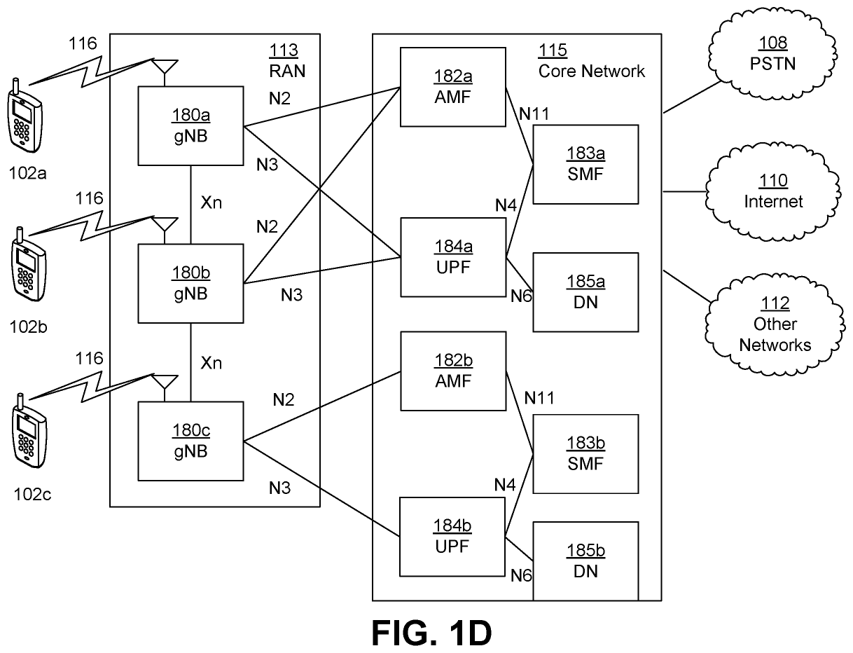

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein for joint transmission (JT) channel state information (CSI) reporting. Joint transmission CSI may be coherent JT CSI or non-coherent JT CSI. Feedback overhead may be reduced, for example, if reporting CSI for multiple transmission/reception points (TRPs). Precoding matrix indicators (PMIs) and/or co-phasing information for TRPs in JT (e.g., coherent JT or non-coherent JT) may be reported. A wireless transmit/receive unit (WTRU) may be configured to employ operations to reduce feedback overhead and/or report PMIs and/or co-phasing information for TRPs in JT.

The WTRU may receive CSI reporting configuration information indicating a set of codebook indices (CIs) and a plurality of TRPs. The CSI reporting configuration information may indicate a number of columns in a matrix (e.g., spatial domain matrix, frequency domain matrix, etc.) that are associated with a (e.g., each) TRP in the plurality of TRPs. The WTRU may determine PMI information for subsets of TRPs from the plurality of TRPs (e.g., where the subsets of TRPs may be determined by the WTRU and/or indicated in the CSI reporting configuration information). The WTRU may determine the PMI information based on receiving and/or measuring RSs (e.g., CSI-RSs) The PMI information may include a channel quality indicator (CQI) value. The WTRU may determine a subset of TRPs (e.g., from multiple subsets of TRPs or the plurality of TRPs), for example, based on the PMI information (e.g., the subset of TRPs with the highest CQI value may be selected). The WTRU may determine that at least two TRPs in the determined subset of TRPs are basis sharing (e.g., in the spatial domain and/or frequency domain), for example, based on the configuration information (e.g., CIs). The WTRU may send a CSI report associated with the selected subset of TRPs. The CSI report may indicate the determined subset of TRPs and the determined PMI information associated with the determined subset of TRPs. The CSI report may include a shared CI associated with the at least two TRPs that are basis sharing, for example, to reduce signaling overhead. The CSI report may include a non-shared CI associated with TRPs in the subset of TRPs that are not basis sharing.

Compression operations may be enhanced, for example, to reduce overhead information. For example, a WTRU may report a basis set (e.g., spatial basis set, frequency basis set, time basis set, etc.) for a coherent JT TRP. The WTRU may be configured to report a compressed basis set. The WTRU may be configured to report a compressed basis set shared for multiple coherent JT TRPs. The WTRU may be configured to report coefficient sets. The WTRU may be configured to report coefficient sets per TRP.

The WTRU may be configured to generate a basis matrix, for example, for PMI calculation. The WTRU may be configured to generate a basis matrix using basis sets from TRPs (e.g., different associated TRPs).

The WTRU may be configured to report CSI. The CSI may comprise CSI components. The WTRU may be configured to report different CSI component granularities, such as, for example, a number of bases, a number of coefficients, etc. The WTRU may be configured to report different CSI component granularities, for example, for coherent JT TRPs (e.g., different coherent JT TRPs).

The WTRU may report CSI (e.g., PMI) for a TRP. The WTRU may be configured to receive an indication indicating a set of TRP pairs. The WTRU may be configured to receive configuration information indicating a set of resources associated with CSI reporting. The WTRU may be configured to determine CSI for each TRP pair in the set of TRP pairs. The WTRU may be configured to determine that the set of resources is below a threshold associated with the set of TRP pairs (e.g., the amount of resources in the set of resources is insufficient to accommodate all TRP pairs). The WTRU may be configured to determine a subset of TRP pairs. The subset of TRP pairs may be determined from the set of TRP pairs. The WTRU may be configured to perform measurements (e.g., RSRP) on the TRPs in the set of TRP pairs. The WTRU may select TRPs for the subset of TRPs, for example, if the performed measurements for a TRP are above a threshold. The WTRU may be configured to send a set of CSI. The WTRU may select CSI reporting contents. For example, the WTRU may select CSI reporting contents as a function of RS groups and/or port groups. The set of CSI may include CSI associated with the TRP pairs in the subset of TRP pairs. For example, the WTRU may report CSI for the subset of TRPs for which it has sufficient resources. In examples, the WTRU may report CSI for a secondary TRP, for example, that is conditioned on a primary TRP's CSI (e.g., PMI).

The WTRU may be configured to switch between reporting settings. For example, the WTRU may switch between reporting an aggregated PMI for an aggregated channel (e.g., from coherent JT TRPs) and reporting per TRP PMI and a co-phasing factor.

The WTRU may determine a transmission configuration indicator (TCI), for example, for CSI resources. The TCI may indicate an association between a physical channel (e.g., used for transmission) and a transmission (e.g., reference signal transmission, such as a demodulation reference signal transmission) sent using the physical channel. The WTRU may determine a TCI per port. The WTRU may determine a TCI per port group for CSI resources with multiple port groups.

The channel state information (CSI) reporting framework may be enhanced, for example, to support an efficient reporting setting (e.g., for scenarios with multiple TRPs in Non-Coherent Joint Transmission (NC-JT)). CSI resource and reporting settings may be enhanced, for example, without changes to codebooks (e.g., any codebooks).

Coherent joint transmission (C-JT) may include (e.g., refer to) where more than one transmission/reception point (TRP) transmits (e.g., simultaneously) to a WTRU. Data may be available and may be sent from TRPs (e.g., multiple TRPs at the same time). A precoder may ensure that a signal is received (e.g., coherently received) at the WTRU. The precoder may be applied across multiple antennas located at multiple TRPs.

MIMO may improve CSI acquisition (e.g., for frequency division duplex (FDD) C-JT), for example, through enhancements to the Type II CSI reporting framework.

CSI acquisition may be enhanced for Coherent-JT (e.g., targeting FR1 and TRPs (e.g., up to four TRPs)), for example, assuming ideal backhaul and synchronization and the number (e.g., same number) of antenna ports across TRPs. Type-II codebook refinement (e.g., for C-JT mTRP targeting FDD and its associated CSI reporting) may be provided, for example, taking into account throughput-overhead trade-off.

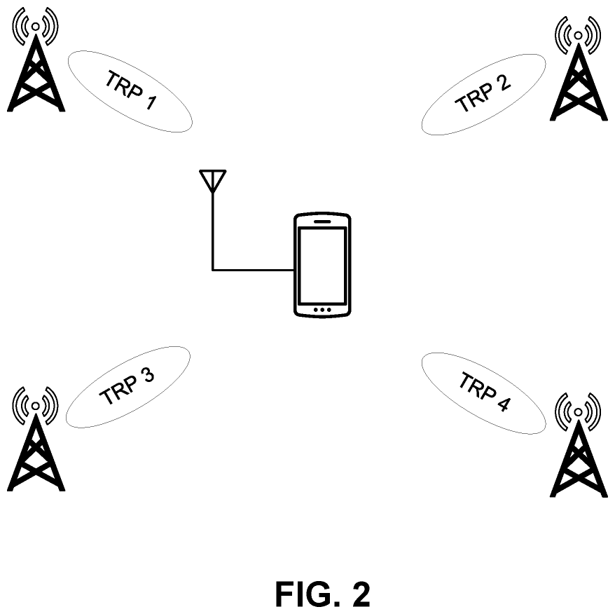

FIG. 2 illustrates an example of joint transmission from multiple TRPs to a WTRU.

A CSI reporting framework may not be optimized, for example, to report Type II CSI for C-JT. A (e.g., each) WTRU-TRP link may use (e.g., require) CSI (e.g., accurate CSI) at the network side (e.g., if/when considering C-JT with multiple TRPs, e.g., as shown in FIG. 2), for example, to enable C-JT with precoders (e.g., correctly co-phased precoders). Reusing Type II with mTRP may use (e.g., require) CSI reporting overhead (e.g., significant CSI reporting overhead), for example, due to the number (e.g., high number) of CSI components reported in Type II, the multiple UE-TRP links, and/or different pairs of candidate TRPs for C-JT. Feedback for C-JT may be refrained from being acquired (e.g., not be acquired) through the (e.g., existing) Type II codebook, for example, because there may not be a standard reporting associated with the co-phasing information between TRPs. The co-phasing may be used (e.g., needed) at the network side, for example, to precode (e.g., accurately precode) a C-JT.

Feedback overhead may be reduced, for example, if (e.g., when) reporting Type II CSI for multiple TRPs. A precoding matrix indicator (PMI) and/or co-phasing information for TRPs for C-JT measurement(s) may be reported.

A beam may be defined. A WTRU may transmit or receive a physical channel or reference signal according to a (e.g., at least one) spatial domain filter. The term beam may be used to refer to a spatial domain filter.

The WTRU may transmit a physical channel or signal using the same spatial domain filter as the spatial domain filter used for receiving an RS (e.g., such as an CSI-RS) or a synchronization signal (SS) block. The WTRU transmission may be referred to as a target. The received RS or SS block may be referred to as a reference or source. In such case, the WTRU may transmit (e.g., may be said to transmit) the target physical channel or signal, for example, according to a spatial relation with a reference to such RS or SS block.

The WTRU may transmit a first physical channel or signal according to the same spatial domain filter as a spatial domain filter used for transmitting a second physical channel or signal. The first transmission may be referred to as target and the second transmission may be referred to as a reference or source. In such case, the WTRU may transmit (e.g., be said to transmit) the first (e.g., target) physical channel or signal according to a spatial relation with a reference to the second (e.g., reference) physical channel or signal.

A spatial relation may be implicit, for example, configured by signaling (e.g., RRC signaling), or signaled by a MAC CE or DCI. For example, a WTRU may transmit (e.g., implicitly transmit) a PUSCH transmission and/or DM-RS of a PUSCH transmission according to the same spatial domain filter as an SRS indicated by an SRS resource indicator (SRI), for example, indicated in DCI or configured via signaling (e.g., via RRC signaling). In examples, a spatial relation may be configured by signaling (e.g., via RRC signaling) for an SRI or signaled (e.g., by a MAC CE) for a PUCCH transmission. Such spatial relation may (e.g., also) be referred to as a beam indication.

The WTRU may receive a first (e.g., target) downlink channel or signal according to the same spatial domain filter or spatial reception parameter as a second (e.g., reference) downlink channel or signal. For example, such association may exist between a physical channel (e.g., such as PDCCH or PDSCH) and its respective RS (e.g., DM-RS). Such association may exist, for example, if (e.g., when) the WTRU is configured with a quasi-colocation (QCL) assumption type D between corresponding antenna ports (e.g., at least if/when the first and second signals are reference signals). Such association may be configured as a transmission configuration indicator (TCI) state. A WTRU may receive an indication indicating an association between a CSI-RS or SS block and a RS (e.g., DM-RS), for example, by an index associated with (e.g., to) a set of TCI states configured by signaling (e.g., via RRC signaling and/or signaled by a MAC CE). Such indication may be referred to as a beam indication.

RS may be interchangeably used with one or more of an RS resource, an RS resource set, an RS port, and/or an RS port group. RS may be interchangeably used with one or more of an SSB, an CSI-RS, an SRS, and/or an DM-RS. A TRP (e.g., transmission and reception point) may be interchangeably used with one or more of transmission point (TP), reception point (RP), radio remote head (RRH), distributed antenna (DA), base station (BS), a sector (e.g., of a BS), and/or a cell (e.g., a geographical cell area served by a BS). Multi-TRP may be interchangeably used with one or more of MTRP, M-TRP, and/or multiple TRPs.

Configuration information associated with TRPs, SRIs, and/or PL reference RS(s) may be provided. A WTRU may be configured with or may receive configuration information associated with one or more TRPs (e.g., a plurality of TRPs), for example, to which the WTRU may transmit and/or from which the WTRU may receive. The WTRU may be configured with one or more TRPs for one or more cells. A cell may be a serving cell or a secondary cell.

A WTRU may be configured with an RS (e.g., at least one RS), e.g., for the purpose of channel measurement. This RS may be denoted as a channel measurement resource (CMR). The CMR may comprise a CSI-RS, SSB, or other downlink RS transmitted from the TRP to a WTRU. A CMR may be configured with or associated with a TCI state. A WTRU may be configured with a CMR group or a RS group (RSG), for example, which may include CMR indices transmitted from the same TRP. A (e.g., each) group may be identified by a CMR group index (e.g., group 1). A WTRU may be configured with one CMR group per TRP. The WTRU may receive a linkage between a (e.g., one) CMR group index and another CMR group index, or between a (e.g., one) RS index from one CMR group and another RS index from another group. A WTRU may determine that linked resources may be configured for C-JT MTRP channel(s) and/or CSI measurement(s).

A WTRU may be configured with or receive configuration information associated with one or more pathloss (PL) reference groups (e.g., sets) and/or one or more SRS groups, SRS resource indicator (SRI), and/or SRS resource sets.

A pathloss (PL) reference group may correspond to or may be associated with a TRP. A PL reference group may include, identify, correspond to, and/or be associated with one or more TCI states, SRIs, reference signal sets (e.g., CSI-RS set, SRI sets), CORESET index, and/or reference signals (e.g., CSI-RS, SSB, etc.).

A WTRU may receive configuration information (e.g., any configuration information as described herein). The configuration information may be received from a base station (e.g., gNB) or TRP. For example, the WTRU may receive configuration information associated with one or more TRPs, one or more PL reference groups, and/or one or more SRI sets. A WTRU may determine (e.g., implicitly determine) an association between an RS set/group and a TRP. The WTRU may transmit (e.g., determine to transmit) to TRP1 with SRS in the first resource set and to TRP2 with SRS in the second resource set, for example, if the WTRU is configured with multiple (e.g., two) SRS resource sets. The configuration information may be received via signaling (e.g., RRC signaling).

A WTRU may receive an indication of a primary and secondary TRP. The WTRU may determine that one of the TRP is the primary or anchor TRP, for example, if (e.g., when) a WTRU is configured with multiple TRPs. This designation may be based on a network configuration or WTRU determination (e.g., received signal quality for one TRP is above all other TRP's received signal quality, or above a threshold).

TRP, PL reference group, SRI group, and SRI set may be used interchangeably (e.g., as described herein). The terms set and group may be used interchangeably (e.g., as described herein).

A coherent joint transmission system with multiple (e.g., two) TRPs may be considered. The operations and/or processes (e.g., as described herein) may be employed for cases with more than two TRPs. In examples, one of the TRPs may be considered as the primary TRP.

Grant or assignment properties may be provided. A property of a grant or assignment may include one or more of the following: a frequency allocation; an aspect of time allocation, such as a duration; a priority; a modulation and coding scheme; a transport block size; a number of spatial layers; a number of transport blocks; a TCI state, CRI, or SRI (e.g., wherein a TCI state, CRI, or SRI may be for each WTRU's panel, for example, if multiple panels are used for a UL transmission); a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); any parameter provided by signaling (e.g., in a DCI, by MAC signaling, or by RRC signaling) for the scheduling the grant or assignment; whether the grant is for single-TRP transmission or multi-TRP transmission; whether the grant is for UL transmission from a single WTRU panel (TxSP) or simultaneous UL transmission from multiple WTRU panels (STxMP); whether the grant is for a C-JT or a noncoherent joint transmission (NC-JT).

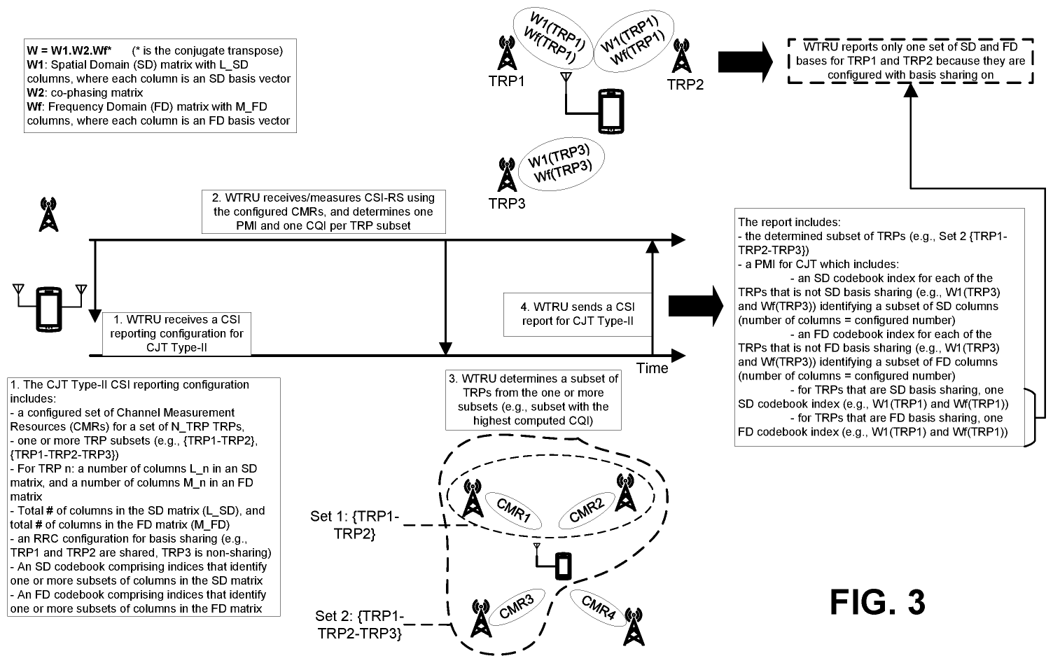

CSI components may be provided and/or reported. A WTRU may report a subset of channel state information (CSI) components, for example, where CSI components may correspond to one or more of the following: a CSI-RS resource indicator (CRI), a SSB resource indicator (SSBRI), an indication of a panel used for reception at the WTRU (e.g., such as a panel identity or group identity), measurements (e.g., such as L1-RSRP, L1-SINR taken from SSB or CSI-RS (e.g., cri-RSRP, cri-SINR, ssb-Index-RSRP, ssb-Index-SINR)), and/or other channel state information (e.g., such as at least rank indicator (RI), channel quality indicator (CQI), precoding matrix indicator (PMI) (e.g., which may include CIs (e.g., spatial domain CIs, frequency domain CIs, etc.) as shown in FIG. 3), Layer Index (LI), and/or the like).

Compression enhancements may be provided. Compression may be enhanced. A precoding (e.g., high-resolution precoding) may be composed of components (e.g., several components). A high-resolution precoding mechanism may be based on multiple CSI components, for example, including one or more of a wideband (W1), narrowband (W2), and/or at least a (e.g., one) set of base vectors for compression (e.g., W_comp1, W_comp2, etc.).

In examples, a high-resolution precoding mechanism may be associated with Type II CSI (e.g., that is based on wideband CSI (W1), narrowband CSI (W2), and frequency-domain compression based on Wf). W1 may represent a set (e.g., preferred set) of beams (e.g., dual-polarized beams) for a (e.g., each) MIMO transmission layer. W1's structure may consist of a matrix with L1 columns corresponding to L1 spatial beams (e.g., L1 basis vectors), and R rows corresponding to the basis length (e.g., where a number of columns may be associated with a TRP from a plurality of TRPs, as shown in FIG. 3). The set of spatial beams used for constructing W1 may be defined as a spatial basis of beams. W1 may be based on a block-diagonal structure to represent the orthogonal polarization of transmit antenna set up. W1 CSI may include a wideband coefficient for indication of a power setting per beam (e.g., preferred power setting per beam). The W2 CSI may include amplitude information (e.g., additional amplitude information) and co-phasing information (e.g., additional co-phasing information), for example, for indication of preferred linear beam combining per subband.

Subband information may be compressed in a frequency domain (e.g., by indicating a subset of L2 basis compression vectors in a matrix Wf and a set of dominant coefficients), for example, to reduce the overhead information associated to the indication of subband information.

A set of L3 compression vectors in time domain Wt and a (e.g., one) coefficient per vector in Wt may be considered. The WTRU may further reduce the CSI reporting overhead, for example, by compressing a set of N samples in time domain into the set of L3 time compression vectors Wt.

In total, a WTRU may report a (e.g., one) set of compression vectors in space, a (e.g., one) set of compression vectors in frequency, a (e.g., one) set of compression vectors in time, a (e.g., one) coefficient per spatial compression vector, a (e.g., one) coefficient per frequency compression vector, and/or a (e.g., one) coefficient per time compression vector. The WTRU may report a (e.g., each) coefficient as an amplitude and phase element index, for example, where the elements may be derived from a codebook of quantized amplitude and phase elements.

A WTRU may report CSI feedback, for example, for C-JT. High resolution precoding mechanisms may be used in a multi-TRP CJT transmission. FIG. 3 illustrates an example of CSI reporting for multi-TRP CJT. A WTRU may receive a grant (e.g., dynamically in a DCI, or preconfigured in a CG) indicating an mTRP scheduling with an indicator (e.g., explicit indicator) of C-JT from more than one TRP (e.g., a plurality of TRPs), and with the indices (e.g., codebook indices (CIs)) of the TRPs. A WTRU may receive data (e.g., a PDSCH transmission) sent from mTRP with a C-JT precoder, for example, where the precoder (e.g., PMI information) is determined based on the WTRU feedback (e.g., PMI information may be determined based for a subset of TRPs from the plurality of TRPs, as shown in FIG. 3). A per TRP direct use of the feedback mechanism may cause an increase (e.g., significant increase) in the uplink CSI feedback channel. To limit the increase in the uplink control channel one or more of the following methods may be used in a multi-TRP CJT system.

The WTRU may report a (e.g., one) basis set shared for multiple TRPs (e.g., as shown in FIG. 3). In examples, basis sharing may be referred to as an operation where a WTRU may report (e.g., in a CSI report) a (e.g., one) set of basis vectors (e.g., spatial, frequency, or time) that may be associated to (e.g., shared by) more than one TRP (e.g., the WTRU may report PMI information that includes a shared CI for the basis sharing TRPs (e.g., at least two TRPs that are determined to be basis sharing)). The WTRU may determine that at least two TRPs are determined to be basis sharing (e.g., in the spatial domain, frequency domain, etc.), for example, based on the received CSI configuration information (e.g., CJT Type-II CSI reporting configuration information as shown in FIG. 3). For example, (e.g., instead of reporting one W1/Wf/Wt per TRP) a WTRU may report a (e.g., one) W1/Wf/Wt for TRP1 and TRP2, and a (e.g., one) W2, frequency, and time coefficients per TRP, respectively. In this case, a WTRU may report (e.g., may be said to report) a shared W1/Wf/Wt (e.g., a shared CI) for TRP1 and TRP2.

A WTRU may generate a CSI report, for example, where a (e.g., one) set of basis compression vectors (e.g., a shared set of basis compression vectors, a shared CI, etc.) may be associated to multiple TRPs. The WTRU may (e.g., explicitly) indicate the TRP pairs (e.g., the TRP pairs for which basis compression vectors are shared) in the CSI report. For example, a WTRU may indicate that TRP1 and TRP2 share the same set of L basis, along with the reported L basis. A WTRU may report a CSI for TRP1 and TRP2 using the same L basis in a single CSI report, and report per TRP coefficients. This may apply in spatial/frequency/time domain (e.g., as shown in FIG. 3), where one of the following may apply: a WTRU may indicate a shared (e.g., same) set of spatial basis compression vectors W1 for more than one TRP (e.g., only; a WTRU may indicate a shared (e.g., same) set of time basis compression vectors Wt for more than one TRP; a WTRU may indicate a same set of frequency basis compression vectors Wf for more than one TRP.

A WTRU may report a CSI with basis sharing, for example, based on receiving an indication (e.g., flag) to activate/deactivate basis sharing. In examples, a WTRU may receive a flag for activating basis sharing. If the flag is turned on, a WTRU may generate its CSI report with basis sharing between more than one TRP (e.g., one basis for multiple TRPs). If the flag is turned off, a WTRU may generate its CSI report with no basis sharing (e.g., one basis per TRP).

A WTRU may receive the indication (e.g., flag) as part of a bit field in the CSI reporting configuration information. The WTRU may receive signaling (e.g., via an RRC reconfiguration signal) of CSI reporting configuration information to activate/deactivate the flag.

A WTRU may receive the indication (e.g., flag) as part of the uplink resource configuration information for reporting CSI. For example, a (e.g., one) PUCCH resource may be configured for reporting CSI with shared basis components. A WTRU may determine to generate a CSI report with basis sharing turned on, for example, based on the PUCCH Resource Index (PRI).

A WTRU may receive more than one PRI, and may determine to report shared CSI using multiple PRIs. A WTRU may determine an association between a PRI and a TRP, and may report the CSI on the associated PUCCH resource.

A WTRU may receive a grant for mTRP PUSCH transmission towards multiple TRPs (e.g., alternatively), for example, if the WTRU reports on the PUSCH. A WTRU may report CSI for a TRP on the PUSCH transmission associated to the same TRP (e.g., PUSCH repetition with SRI towards associated TRP's CSI report).

A WTRU may report a shared basis (e.g., alternatively), for example, if the number of configured TRPs or TRP pairs is above a threshold. For example, if a WTRU reports CSI for a (e.g., one) TRP pair, the WTRU may refrain from using basis sharing (e.g., does not use basis sharing). If a WTRU report CSI for more than one TRP pair, the WTRU may use basis sharing between the TRPs in a pair or across pairs.

If the WTRU is configured with more than one TRP, or if a WTRU is configured to report with more than one TRP pair, a WTRU may receive more than one flag (e.g., where the flags may form a bitmap indicating for which TRPs to activate basis sharing). For example, a WTRU may be configured with TRP1, TRP2, and TRP3, and a bitmap associated to the pairs ({TRP1, TRP2}, {TRP1, TRP3}, {TRP2, TRP3}). A WTRU may receive a flag 100, which may indicate to activate sharing if (e.g., when) reporting CSI between {TRP1, TRP2}, and indicate to refrain from sharing (e.g., no sharing) if (e.g., when) reporting CSI for the pairs {TRP1, TRP3}, {TRP2, TRP3}.

The flag may (e.g., alternatively) be associated to a TRP, for example, such that any reporting which includes TRP the indicated TRP index may include basis sharing. For example, a flag may be activated for TRP1, and a WTRU may report a CSI with basis sharing between any TRP pairs which include TRP1 (e.g. TRP1-TRP2 and TRP1-TRP3).

A WTRU may determine a subset of TRPs or TRP pairs for which to report sharing (e.g., based on PMI information or a CQI value, for example, where a first subset of TRPs is determined to have a first CQI value and a second subset of TRPs is determined to have a second CQI value and the first CQI value is higher than the second CQI value, as shown in FIG. 3). For example, a WTRU may receive CSI reporting configuration information indicating that the basis sharing is enabled (e.g., turned on), with multiple TRPs configured, and/or an indication to report one pair (e.g., only). A WTRU may calculate CSI for multiple pairs, and may select a pair (e.g., one pair) out of the multiple pairs for reporting (e.g., based on determine CQI values, as shown in FIG. 3). The WTRU may include an index (e.g., CI) of the selected TRPs or of the TRP pair in the CSI report along with the CSI.

A WTRU may report parameter resolutions (e.g., different parameter resolutions) per TRP (e.g., spatial, frequency, time). In examples, a WTRU may reduce CSI feedback overhead in a multi-TRP CJT by use of one or more the following: a WTRU may indicate a number (e.g., max number) of spatial beams per TRP (e.g., L1, L2, etc.) where the number (e.g., total number) of beams may be specified, semi-statically configured, or dynamically indicated; a WTRU may indicate a (e.g., preferred) wideband amplitude, subband amplitude, and/or co-phasing information for cross TRP beam combining.

For example, a WTRU may indicate a (e.g., max) number of spatial beams per TRP (e.g., L1, L2, etc.) where the total number of beams may be specified, semi-statically configured or dynamically indicated. A WTRU may receive CSI reporting setting configuration information, for example, where the max number of beams per TRP is configured. The WTRU may determine the PMI feedback, for example, as a function of the number of beams. A WTRU (e.g., alternatively) may choose and indicate the number of beams per TRP for W1, for example, based on one or more of the following: the WTRU's angular position to each TRP; a signal quality measurement (e.g., RSRP, etc.); direction of the movement (e.g., approaching or leaving with respect to each TRP); and/or the CSI report, which may include a (e.g., one) field (e.g., new field) per TRP for the WTRU to indicate to the WTRU the selected max number of beams. A WTRU may receive signaling (e.g., via a MAC-CE) which may activate or update the number of beams per TRP.

A WTRU may indicate a (e.g., preferred) wideband amplitude, subband amplitude, and co-phasing information, for example, for cross-TRP beam combining. In examples, a WTRU may indicate a (e.g., preferred) set of wideband amplitude, subband amplitude and co-phasing information for combining a first set of beams from the first TRP with another set of beams from the second TRP.

In examples, a WTRU may choose and may indicate different resolutions for the quantized amplitude and co-phasing information for each TRP. A WTRU may select the resolution per TRP, for example, based on type of TRP, cell, etc. For example, a WTRU may choose a higher resolution quantized amplitude and co-phasing information for the primary TRP as compared to the one used for the other TRP.

A WTRU may select the resolution per TRP based on a signal quality measurement, e.g., RSRP, etc. For example, a higher resolution quantized amplitude and co-phasing information may be utilized for the TRP that corresponds with a stronger signal at the WTRU.

A WTRU may select the quantization resolution per TRP, for example, based on the layer or codeword transmitted from each TRP. For example, a WTRU may report CSI using a higher resolution quantized amplitude and co-phasing information for the first and second layer transmitted from the primary, and a lower resolution quantized amplitude and co-phasing information from other TRP. A WTRU (e.g., alternatively) may select the quantization resolution per TRP, for example, based on the (e.g., total) number layers or codewords transmitted from each TRP. For example, a WTRU may report CSI using a first quantization resolution for amplitude and co-phasing information for a four layer transmission from the first TRP, and a second quantization resolution for amplitude and co-phasing information for a two layer transmission from the other TRP.

In examples, a WTRU may choose and may indicate combinations (e.g., different combinations) of wideband and subband CSI for each TRP. In examples, a WTRU may report both wideband and subband information for a first TRP, and (e.g., only) the wideband CSI for a second TRP. A WTRU may report CSI by using (e.g., both) wideband and narrowband amplitude and co-phasing information. The number of subbands for narrowband CSI reporting may be different for each TRP. A WTRU may receive the combinations as part of the CSI reporting configuration information.

A WTRU may indicate a (e.g., shared or same) set of basis compression vectors (e.g., for frequency domain compression, etc.) for more than one TRP. A WTRU may use a (e.g., different) frequency domain unit for each TRP. For example, a WTRU may consider multiple (e.g., two) frequency units per subband for subband CSI compression of the first TRP, and a (e.g., single) frequency unit per subband for subband CSI compression of the second TRP. Similarly for spatial or time compression, a WTRU may report a different number of coefficients per TRP while reporting one shared (e.g., same) set of basis compression vectors for TRPs (e.g., all TRPs). In examples, a WTRU may (e.g., alternatively) perform frequency domain compression and report subband CSI for subbands (e.g., all subbands) for a first TRP, and for the second TRP, the WTRU may perform frequency domain compression and report subband CSI for (e.g., only for) a (e.g., selected) set of subbands (e.g., odd or even subbands). The WTRU may alternate the CSI information for odd/even subbands for each CSI report. For example, a WTRU may include odd subband information in a first CSI report, and in a second CSI report T seconds later a WTRU may include even subband information.

The WTRU may reports different CSI resolutions, for example, as a function of a mode of operation (e.g., sTRP/mTRP mode of operation).

In examples, a WTRU may determine the resolution/number of basis to report as a function of the indicated sTRP/mTRP mode. A WTRU may receive CSI reporting configuration information indicating multiple (e.g., two) sets of configurations, for example, where a (e.g., one) set of configuration information may be used for sTRP CSI reporting, and another set of configuration information may be used for mTRP C-JT CSI reporting. For example, a WTRU may receive configuration information with an L_sTRP basis for sTRP CSI reporting, and an L_mTRP basis for mTRP CSI. L_mTRP may consist of a subset of all L basis, or of the configured L_sTRP basis. In mTRP mode, a WTRU may determine its CSI by considering (e.g., only considering) pairs formed from L_mTRP1 basis from TRP1 and L_mTRP2 basis from TRP2. For example, a WTRU may calculate CSI for TRP1 using a W1 formed with L_mTRP1 basis, and for TRP2 using a W1 formed with L_mTRP2 basis, for example, where both sets of basis are associated for C-JT CSI reporting.

A WTRU may report a CSI conditioned on a W (e.g., matrix) constructed with basis sets from TRP(s) (e.g., more than one TRP). In examples, a WTRU may construct a basis matrix with a (e.g., one) set of parameters from one TRP and another set of parameters from another TRP, and may generate a CSI report as a function of this basis matrix. For example, a WTRU may generate the W1 matrix of beams using B1 beams from TRP1, and B2 beams from TRP2. The first B1 columns of the W1 matrix may comprise TRP1 beams, and the next B2 columns may comprise TRP2 beams. A WTRU may generate a PMI based on this W1 matrix. A WTRU may receive in the CSI reporting setting (e.g., CSI reporting configuration information) an indication of the TRPs (e.g., a plurality of TRPs), and/or a number and indices of beams per TRP to use for constructing W1. A WTRU may report the W2 indices per TRP.

A WTRU may determine to generate a shared W1 matrix, for example, based on an indication (e.g., flag). The WTRU may use indicated beams from TRP1 and TRP2 to construct W1, for example, if the WTRU receives a flag turned on. The WTRU may generate one W1 per TRP using (e.g., only) the respective TRP's basis set, for example, if the WTRU receives a flag turned off.

The WTRU may report a CSI with basis sharing, for example, depending on RS configuration information. a WTRU may activate (e.g., determine to activate) an (e.g., any) operation as described herein (e.g., basis sharing, W1 construction), for example, based on the RS configuration information associated with CSI reporting configuration information. For example, a WTRU may receive CSI reporting configuration information, for example, where a CSI-RS may be configured with ports associated to multiple (e.g., two) different TRPs (e.g., CSI-RS resource CR11 with two ports where port 1 is sent from TRP1 port 2 from TRP2). A WTRU may determine (e.g., implicitly determine) that such CSI-RS configuration information associated with more than one TRP may be associated with configuration information for mTRP reporting with sharing enabled. A WTRU (e.g., alternatively) may receive a TCI codepoint with more than one TCI state, configuration information with RSs from different TRPs linked together, or TCI states from different TRPs linked together.

A WTRU may determine an association between port groups and TCI states.

A (e.g., one) CSI-RS resource (e.g., associated to multiple TPRs) may be configured with multiple port groups (PGs). A (e.g., each) PG may contain (e.g., multiple) ports from a (e.g., single) TRP. A WTRU may determine an association (e.g., one-to-one association) between a PG and a TCI (e.g., for CSI-RS resources with multiple PGs), for example, to receive PG 1 with TCI state 1 and PG 2 with TCI state 2. The WTRU may determine the TCI states as a function of measurements, for example, using a CSI-RS with a (e.g., single) PG. For example, a WTRU may receive a (e.g., one) CSI-RS resource with a (e.g., single) PG where the (e.g., all) ports are associated with (e.g., belong to) TRP1. The WTRU may determine that PG 1 is associated with TCI1. A WTRU may receive a second CSI-RS resource with (e.g., multiple) PGs, where a PG (e.g., one of the PGs) is PG 1. The WTRU may determine that the ports in the second CSI-RS resource with PG 1 may be associated to TCI1. A WTRU may receive configuration information indicating that the first CSI-RS resource is the source RS for the TCI1 of PG 1. A WTRU may use (e.g., different) spatial receive filters for a (e.g., each) port group (e.g., if the ports are sent in different time slots, or if the ports are received on different panels).

A WTRU (e.g., alternatively) may determine a many-to-one association between PGs and a TCI state, for example, to receive a CSI-RS with more than one PG with a (e.g., single) TCI state. A WTRU may determine the TCI state by receiving the CSI-RS with multiple PGs. A WTRU may determine the (e.g., single) TCI state to receive PG 1 and PG 2. A WTRU may use a (e.g., single) spatial receive filter for the port groups (e.g., both port groups).

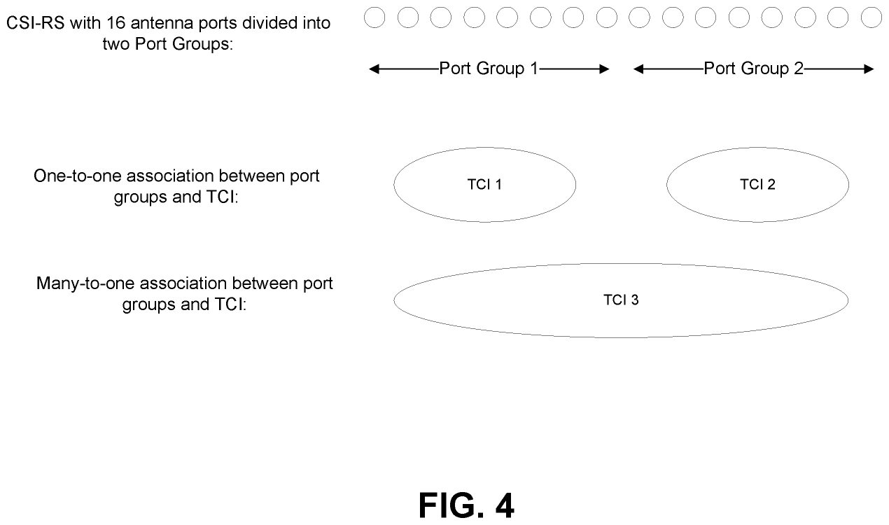

FIG. 4 illustrates example types of association between TCI states and PGs. In examples (e.g., for the one-to-one case), a WTRU may receive CSI-RS configuration information indicating (e.g., two) TCI states (e.g., two TCI states are configured). The (e.g., two) PGs may be configured to associate the antenna ports to the TCI states, for example, such that each TRP/TCI is associated to a (e.g., one) respective PG. In examples (e.g., regarding the many-to-one association), PGs (e.g., two PGs) may be associated to the same TCI state.

A WTRU may receive signaling (e.g., a MAC-CE) indicating to reconfigure the PG association per CMR. A WTRU may receive signaling (e.g., a MAC-CE) indicating to activate different TCI states per port of a CSI-RS resource. The signaling (e.g., MAC-CE) may include a bitmap of length associated with the number of ports (e.g., equal to the number of ports), and one TCI state per bit equal to 1 in the bitmap. For example, a WTRU may receive 1010 for a CSI-RS resource with 4 ports, and TCI states 1 and 2. A WTRU may (e.g., expect to) receive the CSI-RS with ports 1 and 3 from the TRP(s) associated with TCI states 1 and 2.

In examples (e.g., for the one-to-one case), a WTRU may receive signaling (e.g., a MAC-CE) indicating to update the TCI state per PG or for both PGs. The signaling (e.g., MAC-CE) may include one or two TCI states, and the index of the PG associated to the (e.g., each) TCI state update. The signaling (e.g., MAC-CE) may update the PG index association to antenna ports. For example, the WTRU may receive a control message to change PG 2 to PG 3 (e.g., TRP2 to TRP3). A WTRU may change its spatial receive filter for PG3. The WTRU may receive a control message indicating to change the number of ports per PG, and number of PGs per CSI-RS resource (e.g., 2 PGs with 8 ports per group may be updated to 4 PGs with 4 ports per group).

CSI evaluation and reporting may be conditional.

A WTRU may provide CSI information to a base station (e.g., gNB) to assist in a more accurate downlink precoding, for example, in a JT system. A WTRU may determine and report the CSI using different transmission hypotheses and/or assumptions, for example, depending on whether a coherent or non-coherent JT is utilized.

A WTRU may be unaware of the resulting effects from CSI estimation (e.g., the WTRU's reported estimation). A WTRU may report CSI that may be ignored by the base station (e.g., gNB) due to other scheduling limitations (e.g., such as inter and/or intra interference), for example, because a WTRU may be unaware (e.g., does not know) about the channel and spatial information of other WTRUs.

A WTRU may calculate CSI on a set of parameters (e.g., restricted set of parameters) conditioned on a set of parameters from a primary TRP.

In a multi-TRP transmission scenario, CSI reports for channels (e.g., all channels) corresponding to TRPs (e.g., all TRPs) may use (e.g., require) an amount (e.g., excessive amount) of uplink feedback overhead. Some restrictions in CSI reporting may reduce (e.g., help reduce) the uplink feedback overhead and the overall spectrum efficiency of the system. In examples, a WTRU may receive an indication that indicates to the WTRU to assume a specific subset of transmission features (e.g., a beam or a PMI for one TRP to be used for estimation of the CSI of other TRPs). A WTRU may receive such restriction as a list of allowed or not allowed range of feature parameters for CSI estimation.

In examples (e.g., for a given WTRU), a base station (e.g., gNB) may refrain from using (e.g., avoid use of) one or more transmission features (e.g., of certain transmission features) that may harm transmission for another WTRU. For example, a base station (e.g., gNB) may refrain using a (e.g., certain) beam direction and/or precoding choices (e.g., due to interference that may impose on another WTRU). A base station (e.g., gNB) may avoid (e.g., refrain from) transmitting with more than a number (e.g., certain number) of layers to a first WTRU to leave spatial freedom (e.g., a sufficient spatial freedom) for transmission to a second WTRU that may have a similar spatial property as the first WTRU in the system. A WTRU may be indicated to refrain from providing (e.g., not to provide) CSI estimation corresponding to a higher order of modulation, for example, to reduce base station (e.g., gNB) power transmission.

In examples, a WTRU may receive an indication that indicates (e.g., includes) a set (e.g., restricted set) of transmission features that are to be used for CSI estimation and/or reporting by WTRU. A WTRU may receive an indication indicating to exclude one or more of the following for its CSI report: beam direction, for example, that may be indicated by a set of indices that are associated to one or more configured reference signals (e.g., CRI, SSBRI, etc.); precoding matrices, for example, that may be indicated by a set of indices (e.g., precoding matrix indicator or PMI); polarization, for example, that may be indicated explicitly by an index to signal a specific polarization for transmission (e.g., V vs. H, +45 vs. −45, linear vs. circular, etc.); layer, for example, that may be indicated by an indicated rank as the highest allowed rank for CSI estimation (e.g., alternatively, a specific subset of layers may be restricted based on its relative channel eigen power, e.g., the first two layers corresponding to the strongest eigen modes of the channel); and/or modulation, for example, that may be indicated by one or more of MCSs as the highest allowed modulation orders for CSI estimation.

A WTRU may receive an indication indicating such restrictions for one or more TRPs in a system. A WTRU may be configured with (e.g., multiple) CSI restriction settings. The WTRU may be dynamically indicated to use one of the configured settings. A WTRU may receive and apply a different restriction per TRP. For example, a WTRU may receive and apply configuration information associated with CSI_restriction_1 for the first TRP and CSI_restriction_2 for the second TRP.

In examples, a WTRU may receive a period (e.g., validity period) for the CSI restriction setting. For example, a WTRU may receive an indication (e.g., first/start indication) for starting the usage of the indicated CSI restriction setting, and another indication (e.g., second/stop indication) for the termination of the usage of the indicated CSI restriction setting. The start/stop indications may be referenced to reception of CSI request trigger or another point of reference, e.g., SSB position, etc. A WTRU (e.g., alternatively) may receive a time and/or frequency pattern to determine what CSI restriction setting to be used for a given time and/or frequency resource.

A WTRU may choose a (e.g., one of the) configured CSI restriction settings, for example, based on another criterion. A WTRU may determine the CSI restriction setting based on one or more of the following: a measured signal quality (e.g., SNR, RSRP, Doppler, etc.), for example, if it meets a preconfigured threshold; TRP status (e.g., a primary or a secondary, serving or non-serving, cell type, etc.); and/or TRP transmission capability. A WTRU may determine the CSI restriction setting based on TRP transmission capability, based on one or more of the following: the number of transmission port indicated for each TRP; single vs. multi-TRP transmission mode; band of operation, or bandwidth part (e.g., whether is band_x or band_y); power transmission rating; FR1 vs. FR2; coherent vs. non-coherent capability of the transmission; etc.

A WTRU may indicate the employed CSI restriction (e.g., implicitly or explicitly), for example, if (e.g., once) a WTRU selects one of the configured CSI restriction settings. A WTRU may report an index to indicate the used CSI restriction configuration information, for example, where the index may be part of the reported CSI (e.g., a flag in the MAC CE header or UCI payload). If CSI is reported per TRP, the indication of the CSI configuration setting used for other TRPs may be indicated as part of the CSI reported for the primary TRP. A WTRU (e.g., alternatively) may indicate the selected CSI configuration setting for each CSI payload independently.

A WTRU may indicate (e.g., implicitly indicate) the employed CSI restriction setting by selection of a preconfigure uplink resources. For example, a WTRU may indicate selection of a first setting by transmission on a first configured uplink control resource, and indicate selection of a second setting by transmission on a second configured uplink resource.

A WTRU may be dynamically switched between single and multi-TRP operations. A WTRU may select one of the configured CSI settings, for example, according to whether the WTRU is operating in single or multi-TRP mode. In examples, a WTRU may use a first CSI restriction setting for the primary TRP in a multi-TRP mode, and another (e.g., second) setting for the same TRP (e.g., if/when it operates in the single-TRP mode).

A WTRU may include/exclude (e.g., dynamically include/exclude) CSI parameters, for example, as a function of configured TRP pairs.

A WTRU may apply (e.g., be configured to apply) an inclusion/exclusion (e.g., dynamic or semi-static inclusion/exclusion) of PMIs/CRIs for a TRP, e.g., if (e.g., when) performing a CSI reporting, for example, based on (e.g., depending on) which TRP pairs are selected (e.g., best, as described herein). The WTRU may determine (e.g., in a CSI reporting instance) one or more TRPs (e.g., best/preferred TRPs) for communications (e.g., based on determined PMI information associated with the one or more TRPs). The one or more (e.g., best/preferred) TRPs for communications may comprise TRP1 and TRP2 (e.g., a subset of TRPs from the plurality of TRPs). The proposed operations and/or processes (e.g., as described herein) may equally be employed for cases with more than two TRPs selected as the one or more (e.g., best/preferred) TRPs. In examples, one of the TRPs may be the primary TRP (e.g., TRP1).

The selection of TRP1 and TRP2 may be indicated, for example, based on CRIs, CSI-RS resource set ID(s)/index(es), different sets of CSI-RS antenna ports (APs) in a CSI-RS resource, TRP ID(s)/index(es), and/or PMIs reported by the WTRU, e.g., in the CSI reporting instance. In examples, the WTRU may report (e.g., at least) a first CRI value (e.g., CSI-RS resource 7) and a second CRI value (e.g., CSI-RS resource 13), each corresponding to the TRP1 and TRP2, respectively. One or more first CRIs (e.g., comprising the first CRI value at least, e.g., comprised in a CSI-RS resource set ID and/or the like) may correspond to (e.g., be associated with) TRP1, e.g., via signaling (e.g., such as via RRC signaling and/or MAC-CE signaling) or in a pre-defined/pre-determined rule. One or more second CRIs (e.g., comprising the second CRI value at least, e.g., comprised in a CSI-RS resource set ID and/or the like) may correspond to (e.g., be associated with) TRP2, e.g., via signaling (e.g., such as via RRC signaling and/or MAC-CE signaling) or in a pre-defined/pre-determined rule. In examples, the WTRU may report (e.g., at least) a first PMI value (e.g., PMI=4 in a codebook) and a second PMI value (e.g., PMI=11 in a codebook), e.g., in addition to the reported CRI values.

A pair (e.g., one or more pairs) of CSI-RS resources (e.g., the first CRI value and the second CRI vale), corresponding to each TRP, may be pre-defined (e.g., identified, determined), for example, for the inclusion/exclusion (e.g., dynamic or semi-static inclusion/exclusion) of PMIs/CRIs for a TRP. A pair (e.g., one or more pairs) of CSI-RS resources (e.g., the first CRI value and the second CRI vale) corresponding to each TRP may be indicated (e.g., explicitly indicated) or configured to the WTRU, for example, for the dynamic or semi-static inclusion/exclusion of PMIs/CRIs for a TRP. In examples, the WTRU may determine (e.g., select) the first CRI value for TRP1 (e.g., as a primary TRP) firstly. In response to determining the first CRI value, the WTRU may determine that the first CRI value is included in the pair of CSI-RS resources. The WTRU may determine (e.g., select) the second CRI value for TRP2 in response to the determining that the second CRI value is included in the pair of CSI-RS resources (e.g., not allowed to select other CRI value for TRP2, but to select a CRI value only within the pair of CSI-RS resources), which may be interpreted as an example of the dynamic or semi-static inclusion/exclusion of CRIs for a TRP. This may provide benefits that (e.g., based on a geographical TRP distributions/deployments and a network/cell planning) a base station (e.g., gNB) may configure one or more candidate pairs of CRIs being able to be selected by the WTRU, e.g., so that operation complexity may be reduced and/or downlink performance/efficiency based on the CRI reporting may be improved.

A pair (e.g., one or more pairs) of a first set of one or more CSI-RS APs and a second set of one or more CSI-RS APs in a CSI-RS resource may be pre-defined (e.g., identified, determined), for the dynamic (or semi-static) inclusion/exclusion of PMIs/CRIs for a TRP, where the one or more pairs may be configured via signaling (e.g., such as RRC signaling and/or activated via a MAC-CE and/or indicated by a DCI). In examples, the WTRU may report (e.g., at least) a first PMI value (e.g., PMI=6 in a codebook) determined based on the first one or more CSI-RS APs and a second PMI value (e.g., PMI=17 in a codebook) determined based on the second one or more CSI-RS APs, e.g., each PMI value corresponding to each TRP. This may provide benefits that (e.g., based on a geographical TRP distributions/deployments and a network/cell planning) a base station (e.g., gNB) may configure one or more candidate pairs of CSI-RS APs in a CSI-RS resource (e.g., each set of APs corresponding to or associated with each TRP), e.g., so that operation complexity may be reduced and/or downlink performance/efficiency based on the CSI reporting may be improved.

A WTRU may be configured (e.g., activated, indicated) with one or more candidate codebook subset restriction (CBSR) sets, e.g., for the dynamic or semi-static inclusion/exclusion of PMIs/CRIs for a TRP (e.g., for a secondary TRP other than the primary TRP). The one or more CBSR sets may be semi-statically indicated/configured from a gNB, e.g., via signaling (e.g., such as via RRC signaling and/or MAC-CE signaling). The one or more CBSR sets may be dynamically indicated from a gNB, e.g., via a MAC-CE and/or a DCI. In an example, the WTRU may be configured (e.g., activated, indicated) with CBSR set1, CBSR set2, and CBSR set3, etc. A CBSR set (e.g., one of CBSR set1, CBSR set2, and CBSR set3, etc.) may be associated (e.g., based on the gNB's configuration information/indication) with one or more first PMIs for TRP1 (e.g., the primary TRP). The WTRU may (e.g., firstly) select/determine a first PMI (e.g., W1 matrix comprising beam candidates) from the one or more first PMIs, e.g., for a CSI reporting instance, which may be a best/preferred PMI for communications with TRP1. The WTRU may be allowed to determine/select the one or more first PMIs based on a CSI-RS resource or a CSI-RS resource set associated with the TRP (e.g., TRP1)). Based on determining the first PMI, the WTRU may determine that the first PMI has an association to one of the CBSR sets (e.g., configured CBSR sets). The WTRU may determine that the first PMI has an association to the CBSR set3, for example. In response to determining that the first PMI has an association to one of the CBSR sets, the WTRU may determine (e.g., select) a second PMI (e.g., W1 matrix (e.g., comprising beam candidates) from one or more second PMIs within the CBSR set3 (e.g., where the WTRU is refrains from selecting (e.)g., not allowed to select) the second PMI that is not within (e.g., outside) the CBSR set3)). This may provide benefits in that the WTRU may determine the second PMI within the CBSR set 3 (e.g., for TRP2, associated with TRP2) based on that the WTRU (e.g., firstly) determines the first PMI for TRP1 (e.g., a primary TRP), e.g., so that operation complexity (e.g., for MTRP scenario) may be reduced and/or downlink performance/efficiency based on the CBSR sets may be improved.

In examples, the WTRU may determine/select a CRI and/or a PMI for TRP2 first (e.g., based on a configuration parameter and/or an indication from a gNB). In response to determining a CRI and/or a PMI for TRP2, the WTRU may (e.g., secondly) determine/select a second CRI and/or a second PMI for TRP1, for example, based on at least one of the one or more CBSR sets and/or the one or more pairs of CSI-RS resources, e.g., for the dynamic or semi-static inclusion/exclusion of PMIs/CRIs for a TRP. In examples, the WTRU may determine which TRP's CRI, PMI, and/or the like is selected first (e.g., based on a dynamic selection by a gNB or WTRU-oriented selection). The WTRU may indicate/report (e.g., be configured to indicate/report) which TRP is the primary TRP (e.g., through an explicit indicator, or implicitly through ordering of PMIs in the report). This may provide benefits that the WTRU may determine (e.g., be configured to determine) to change an anchor (e.g., linkage, reference) dynamically between a primary TRP and a secondary TRP.

In examples, a look-up table may be pre-configured or pre-defined, for example, to indicate association between a PMI or PMI group of a first TRP or a first CSI-RS resource and a CBSR set of a second TRP or a second CSI-RS resource. TRP may be interchangeably used with CSI-RS resource, CSI-RS resource index, Cell, Physical cell-id, measurement RS, and SSB. PMI may be interchangeably used with CSI-RS resource index (CRI), CQI, rank, strongest layer indicator (SLI), beam index, source RS index, and SSB index. A first TRP may be a primary TRP for which a PMI may be determined and the PMI for the first TRP may determine one or more of CBSR sets for the rest of TRPs grouped with the first TRP. A primary TRP may be one or more of the following: a serving TRP, a serving cell, a TRP associated with a cell-defining SSB, a TRP associated with a highest link quality (e.g., L1-SINR, L1-RSRP), a TRP associated with PDCCH search space wherein a WTRU may receive DCI scheduling PDSCH transmission and/or PUSCH transmission, a TRP associated with a CORESET with a specific coresetPoolld (e.g., coresetPoolld=0), a TRP associated with a CSI-RS resource having a largest number of antenna ports, a TRP associated with CORSET #0, and/or a TRP indicated as primary TRP from a gNB. CBSR sets may be configured or defined commonly for TRPs (e.g., all TRPs). CBSR sets may (e.g., alternatively) be configured or defined for each TRP. A number of bits of one or more PMIs (e.g., PMIs for one or more TRPs) for CSI reporting may be determined, for example, based on which index is determined for a first PMI. A (e.g., each) CBSR set may have a different number of precoders. The feedback overhead for one or more PMIs may be determined, for example, based on which CBSR sets are determined for the rest of TRPs. A separate coding (e.g., channel coding, channel encoding) may be used for a first PMI and the rest of PMIs which may be determined from the CBSR sets associated with the first PMI.

Table 1 illustrates an example of association between a first PMI of a first TRP and CBSR sets for other TRPs grouped with the first TRP.

TABLE 1

| PMI (or PMI group) | | | |
|---|---|---|---|
| determined for a first | CBSR set for a second | CBSR set for a third | CBRS set for a fourth |
| TRP (e.g., TRP #1) | TRP (e.g., TRP #2) | TRP (e.g., TRP #3) | TRP (e.g., TRP #4) |
| 1 | CBSR set #1 | CBSR set #2 | CBSR set #4 |
| 2 | CBSR set #3 | CBSR set #1 | CBSR set #2 |
| 3 | CBSR set #2 | CBSR set #2 | CBSR set #3 |
| . . . | . . . | . . . | . . . |
| N | CBSR set #1 | CBSR set #4 | CBSR set #2 |

A WTRU may determine one or more CSI reporting quantities for a first TRP, for example, based on one or more CSI reporting quantities determined for a second TRP, wherein the first TRP and the second TRP may be grouped for a CSI reporting. One or more of following may apply.

A CSI reporting quantity may be one or more of the following (e.g., at least one of but not limited to): CQI, PMI, RI, SLI, and CRI. For example, if a WTRU determined a RI value (e.g., RI=2) for a first TRP (e.g., TRP #1), the WTRU may use the determined RI value for a second TRP (e.g., TRP #2).

A subset of CSI reporting quantities may be determined (e.g., commonly determined) for one or more TRPs grouped together for a CSI reporting. The rest of CSI reporting quantities may be determined individually for each TRP in the group. The subset may be indicated, configured, and/or determined by a base station (e.g., gNB). The subset may be determined based on the number of TRPs in the group. The subset may be determined based on one or more CSI reporting types (e.g., CSI reporting configuration information).

In examples, a WTRU may determine a CBSR set for a TRP, for example, based on the geographical location of the WTRU. For example, a base station (e.g., gNB) may configure a CBSR set for a (e.g., specific) geographical location for a TRP, for example, wherein the geographical location may be (e.g., at least) one of GPS coordination, zone identity, proximity to a specific TRP, location determined based on a measurement of positioning reference signal (PRS), and/or measurement quality of a reference signal.

A WTRU may receive CSI reporting configuration information where the WTRU may be indicated to include restricted CSI. This may be indicated as a flag to turn on/off one of the CSI restrictions (e.g., as described herein).

A Type II CSI reporting structure for C-JT may be provided.

A WTRU may receive configuration information to report a Type II CSI for a TRP (e.g., single TRP). The CSI reporting configuration information may be indicate a reporting type codebookType=type2 or type2-r16. A WTRU may report a (e.g., one) set of CSI components for an (e.g., one) associated channel measurement resource (CMR), for example, where the CMR may be a reference signal (e.g., CSI-RS) indicated in the CSI measurement setting, and where one CSI-RS may be associated to one TCI state. A WTRU may expect a (e.g., only one) CSI-RS resource to be configured in a resource set for channel measurement.

Enhancements to the Type II CSI reporting configuration information and WTRU reporting may be provided. The enhancements may enable the WTRU to report CSI components, for example, assuming C-JT transmission from more than one TRP.

CSI reporting configuration information for mTRP C-JT CSI may be provided. In examples, a WTRU may receive configuration information to report a Type II CSI for mTRP C-JT. A WTRU may report a set (e.g., more than one set) of Type II CSI components, for example, where each component may be associated to a TRP. The WTRU may determine to report mTRP CSIs through an explicit or implicit indication in a CSI reporting setting.

A WTRU may receive a CSI reporting setting with RS resources for channel measurement configured for mTRP C-JT, for example, in an implicit operation. The CSI reporting setting may be configured with one or more of the following: an (e.g., more than one) RS resource in a resource set for channel measurement (e.g., where each RS may be associated to a different TCI state or QCL Type-D indication); or with an (e.g., at least one) RS associated with more than one TCI states. The WTRU may determine that such configuration information may implicitly correspond to a C-JT CSI reporting assumption. For example, a subset of ports (e.g., first subset of ports) may be associated with a (e.g., one) TCI (e.g., first TCI), and another subset (e.g., second subset of ports) may be associated to a different TCI (e.g., second TCI).

A WTRU may receive a CSI reporting setting which may be configured for mTRP reporting as a (e.g., new) codebook type, codebookType=type2-r18, or type2-mTRP-r18, for example, for an explicit operation. The WTRU may receive a set of RS (e.g. CMRs), and a grouping of RSs, for example, where each group corresponds to a TRP. The WTRU may receive a bitmap, for example, which may pair RSs together from different groups. The WTRU may receive an indication of the measurement hypothesis for each pair (e.g. sTRP, C-JT or NC-JT). The pair may consist of multiple (e.g., at least two) RS groups. The WTRU may report CSI assuming the transmission hypothesis from the TRP pair associated to the RS pair.

The WTRU may receive configuration information indicating C-JT pairs and may report CSI for the indicated pairs.

The WTRU may receive a set of TRP pairs for C-JT. A subset of pairs may be activated, for example, dynamically or semi-statically activated. The WTRU may receive the pair activation through DCI or via signaling (e.g., such as MAC-CE signaling). The WTRU may measure CSI for the pairs (e.g., all pairs or only the activated subset of pairs). The WTRU may determine to include CSI components only for activated pairs.

A WTRU (e.g., alternatively) may receive a set of activated TRPs. The WTRU may include CSI components for pairs which have an activated TRP (e.g., only for pairs which have an activated TRP). For example, a WTRU may receive configuration information indicating pairs {TRP1-TRP2} and {TRP2-TRP3}, and the WTRU may receive an activation command for TRP1 and TRP2. The WTRU may determine to report (e.g., only report) CSI for the pair TRP1-TRP2.

The activation command may be included in a signal (e.g., a MAC-CE) where TCI states or codepoints are activated/deactivated, and/or where a (e.g., each) TCI state/codepoint is associated to a TRP. The WTRU may determine that active TRPs are associated with active TCI state/codepoints. A (e.g., one) TCI codepoint may be configured with multiple (e.g., two) TCI states.

The WTRU may omit inactivated TRPs from pairings, for example, if/when reporting CSI. For example, if a WTRU receives CSI reporting configuration information with the pair {TRP1-TRP2-TRP3}, and activation for TRP1 and TRP2, a WTRU may omit TRP3 and may report the CSI (e.g., assuming only the {TRP1-TRP2} pair).

The WTRU may select C-JT pairs and may report indices of pairs and CSI for the selected pairs.

A WTRU (e.g., alternatively) may select a subset of TRP pairs from the set (e.g., entire set) of TRP pairs or from the set of activated TRP pairs. For example, if the grant for CSI reporting (e.g., UCI) does not include (e.g., have) sufficient resources to accommodate the pairs (e.g., all pairs), a WTRU may include CSI for a subset of pairs. The WTRU may report CSI for the selected subset. The WTRU may indicate the selected pair subsets, for example, through a bitmap in the CSI report (e.g., where the WTRU reports a 1 if the activated pair is included). The WTRU may order the CSI reports according to the ordering in the bitmap. The WTRU may determine the subset of pairs based on one or more of the following: a WTRU received signal quality measurement (e.g., a WTRU may measure the RSRP for each TRP, and the WTRU may determine to report the CSI for pairs which include TRPs with an RSRP above a threshold); a synchronization state (e.g., a WTRU may receive an indication of which TRP pairs are in-synch, and the WTRU may report the mTRP CSI for TRP pairs that are in-synch (e.g., only); alternatively, the WTRU may determine which pairs are in-synch based on the delay between reception of RSs from the TRP pairs).

The WTRU may receive CSI configuration information to report PMI per TRP and/or inter-TRP co-phasing.

In examples, a WTRU may report a (e.g., one) Type 2 PMI per TRP. The WTRU may report an inter-TRP co-phasing factor between TRP pairs. The WTRU may report the co-phasing factor, a, for example, such that the WTRU determines an optimal precoder P=[P1 α*P2], where P1 and P2 may be the per TRP (e.g., single TRP) PMIs from a Type II codebook, and α may be the co-phasing factor. P may be defined as the C-JT precoder. For example, a WTRU may receive configuration information to report mTRP Type 2 CSI for TRP1 and TRP2, and co-phasing factor for TRP1 and TRP2. The WTRU may receive the configuration information and determine to report a (e.g., one) PMI per TRP, and one inter-TRP co-phasing factor between TRP1 and TRP2. A WTRU may report a (e.g., one) CQI per TRP, or a (e.g., one) joint CQI conditioned on the C-JT precoder P.

A WTRU may receive a reporting quantity setting, for example, which may indicate to include a co-phasing factor. For example, the WTRU may receive configuration information with a reporting quantity (e.g., new reporting quantity) of the co-phasing factor between TRPs (e.g., reportQuantity set to coPhasing). If/when configured, the WTRU may report the PMI for multiple (e.g., two) TRP pairs conditioned on the reported co-phasing value. The co-phasing reporting may be turned on or off and indicated as part of the CSI reporting configuration information. With the flag on, the WTRU may include the co-phasing. With the flag off, the WTRU may omit the co-phasing.

The WTRU may receive an indication of the granularity of co-phasing reporting. The granularity may be indicated (e.g., explicitly indicated) or determined (e.g., implicitly determined), for example, based on the granularity of other PMI parameters (e.g., in time or frequency). For example, the co-phasing may be reported with the granularity (e.g., same granularity) as configured for PMI or it may independently configured per subband or wideband.

The WTRU may report the PMI with different granularities, for example, depending on the number of pairs reported. For example, a WTRU may receive different sets of configuration information and the WTRU may determine to use a first set of configuration information if the number of pairs is greater than a threshold, and another (e.g., second) set of configuration information if it is less than a threshold (e.g., wideband reporting if/when more than two pairs are reported, subband reporting if/when less than two pairs are reported).

A WTRU may receive CSI configuration information, for example, to report an aggregated PMI for TRPs (e.g., all TRPs).

A WTRU may report a C-JT PMI, for example, without a co-phasing parameter (e.g., an additional co-phasing parameter). A WTRU may receive CSI reporting configuration information, for example, where the reportQuantity may be configured for C-JT (e.g., cjt-PMI). The WTRU may be indicated to report a (e.g., one) PMI associated to the aggregated channel of paired TRPs. For example, a WTRU may receive configuration information with a C-JT pair of {TRP1-TRP2} and receive an indication to report cjt-PMI. The WTRU may report a PMI for the aggregated channel [H1 H2], for example, where H1 and H2 are the channels for the WTRU link to TRP1 and TRP2, respectively. The WTRU may indicate a PMI from a precoding codebook, for example, with Nt1+Nt2 antennas (e.g., where Nt1 and Nt2 are the number of antenna ports from the RS associated to TRP1 and TRP2, respectively). The WTRU may report a CQI conditioned on the aggregated PMI.

A WTRU may receive an indication of RSs that may be paired together for aggregate PMI reporting. If the WTRU receives CSI reporting configuration information with CMR pairs, then the WTRU may determine to aggregate CMRs in the pair, for example, to determine the aggregated channel and report a PMI conditioned on the aggregated channel. An RS (e.g., single RS) may (e.g., alternatively) be transmitted, for example, where a subset of ports may be sent from TRP1 and the remaining ports may be sent from TRP2. The WTRU may determine that such an RS may be used for aggregated channel reporting.

The WTRU may determine to report aggregated PMI or per-TRP PMI and/or report co-phasing based on a flag.

In examples, a WTRU may determine to switch between aggregated PMI or per-TRP PMI and co-phasing reporting, for example, based on a flag. A WTRU may receive a flag as part of the CSI reporting setting to switch between reporting modes.

The WTRU may indicate the hypothesis for the C-JT report.

In examples, a WTRU may determine to report a CSI for mTRP (e.g., assuming different transmission hypothesis). For example, the reporting may be configured with multiple (e.g., two) reporting modes. The WTRU may determine that a (e.g., one) reporting mode is for C-JT and another (e.g., different) reporting mode is for NC-JT. The WTRU may calculate multiple (e.g., two) CSIs (e.g., one for each reporting mode) and may include the (e.g., both) CSIs in a (e.g., one) CSI report. The WTRU may explicitly indicate the reporting mode associated with each CSI or implicitly indicate based on the ordering of CSIs (e.g., C-JT first, NC-JT second).

The WTRU may select CSI reports, for example, based on a priority between C-JT and other hypotheses.

In examples, a WTRU may select CSI reports (e.g., different CSI reports) to include in a CSI report, for example, based on a priority between C-JT measurements and other hypotheses. For example, a WTRU may determine to include C-JT with co-phasing as higher priority over a single TRP CSI, or vice-versa. A WTRU may determine the priority, for example, based on enhancing the CSI priority value with a priority index for C-JT or based on the ordering of CSIs in the CSI report. For example, a WTRU may include C-JT with high priority and may drop CSIs for other hypotheses if they do not fit in the grant for the CSI report.

If the WTRU determines a CSI for more than one TRP pair, a WTRU may drop some of the pairs from the CSI report. The WTRU may receive an indication of high priority TRPs or TRP pairs or the WTRU may determine the high priority TRPs or TRP pairs (e.g., based on received signal quality measurement, anchor TRP index, serving cell ID, traffic type (eMBB vs URLLC)).

A WTRU may include a (e.g., at least one) C-JT CSI in a CSI report, for example, if/when multiple pairs are configured. A WTRU may include a (e.g., at least one) single TRP CSI, for example, if/when multiple pairs are configured. A WTRU may receive configuration information indicating the number of pairs, and number of single TRP CSIs to report. A WTRU (e.g., alternatively) may include (e.g., only) C-JT CSIs in a report.

A WTRU may receive UCI grants (e.g., separate UCI grants) for a (e.g., each) TRP. The WTRU may report per TRP C-JT CSI components on the respective grants. A WTRU (e.g., alternatively) may include C-JT CSI components (e.g., all C-JT CSI components) in a CSI report (e.g., single CSI report) and may send it to a (e.g., one) TRP.

The WTRU may determine CSI reporting contents as a function of a RS group configuration with multiple CMRs from different TRPs.

Multiple (e.g., two) reference signal groups (RSGs) may be configurable to support NC-JT. For example, RSG1 may be configured with CMRs from TRP1 and RSG2 may be configured with CMRs from TRP2. A WTRU may report (e.g., either) an sTRP hypothesis from TRP1 or TRP2 for CMRs from RSG1 and RSG2, respectively, and/or an NC-JT hypothesis for CMRs from different RSGs (e.g., NC-JT with CMR1 and CMR2).

For N>2 TRPs, a WTRU may receive configuration information indicating (e.g., be configured with) N RSGs where an (e.g., each) RSG is associated to a TRP and (e.g., only) contains CMRs associated to that (e.g., associated) TRP. A (e.g., single) TCI state may be configured per CMR or RSG, for example, where the (e.g., each) TCI state corresponds to a TRP beam.

In examples (e.g., for N>2), a WTRU may receive configuration information indicating (e.g., be configured with) CMRs from more than one TRP within a (e.g., one) RSG. For example, a WTRU may receive configuration information indicating a (e.g., one) RSG where CMR1 is from TRP1, and CMR2 is from TRP2. A WTRU may receive configuration information indicating (e.g., be configured) to report CSI with the C-JT assumption as a function of the number of CMRs in the RSG. In this case, the WTRU may receive CMR1 and CMR2 and measure the CSI (e.g., assuming C-JT hypothesis from TRP1 and TRP2). The WTRU may report a (e.g., one) CSI for C-JT hypothesis from TRP1 and TRP2. A WTRU (e.g., alternatively) may (e.g., additionally) report for this RSG the sTRP hypothesis for the (e.g., each) TRP configured in the RSG (e.g., sTRP1 and sTRP2 hypothesis in this case).

A WTRU may determine the association between an RSG and TRPs, for example, as a function of a signaling (e.g., MAC-CE). A WTRU may receive signaling (e.g., a MAC-CE) indicating to reconfigure the CMRs per RSG. The signaling (e.g., MAC-CE) may include the index of the new CMRs forming an RSG (e.g., for RSG reconfiguration). The signaling (e.g., MAC-CE) may (e.g., alternatively) include activation/deactivation signaling (e.g., bit 0 or 1) associated with a (e.g., each) CMR in the RSG. A WTRU may determine that CMRs with bit 1 are activated, and the WTRU may report C-JT CSI for CMRs that are activated.

A WTRU may determine CSI reporting contents as a function of port groups with a (e.g., single) CMR with multiple port groups.

An RSG may be configured for C-JT where the (e.g., every) CMR in the RSG includes (e.g., consists of) CSI-RS resources where different PGs are associated to different TRPs. For example, an RSG may be configured with a CSI-RS resource with 16 ports, and multiple (e.g., two) PGs corresponding to multiple (e.g., two) TRPs. PG 1 may be associated to TRP1 and PG 2 may be associated to TRP2. A (e.g., each) PG may include (e.g., contain) more than one port. PG 1 may include (e.g., contain) 8 ports, and PG 2 may include (e.g., contain) the other 8 ports of the CSI-RS resource. A WTRU may report a C-JT assumption for a (e.g., any) CMR measurement from a RS belonging to such an RSG.

A WTRU may use a codebook (e.g., the Type-II CSI port selection codebook) to report a W2 CSI. A WTRU may use the Type-II CSI port selection codebook to select the TRPs for precoder determination through the PG selection. For example, a WTRU may receive configuration information indicating (e.g., is configured with) a 4 port CSI-RS resource with PG 1 including (e.g., consisting of) ports 1 and 2 associated to TRP1 with TCI state 1, and PG 2 including (e.g., consisting of) ports 3 and 4 associated to TRP2 with TCI state 2. A WTRU may receive the 4 port CSI-RS and measure the channel over the 4 ports.

A WTRU may report a W2 including (e.g., consisting of) ports (e.g., all ports) of the CSI-RS (e.g., the vector [1, 1, 1, 1]) and a (e.g., one) CQI to signal that the WTRU determined the CSI feedback assuming C-JT across all ports for TRP1 and TRP2. The network may receive the W2 and determine to calculate a precoder over TRP1 and TRP2.

In examples, a WTRU may report a W2 including (e.g., consisting of) a subset of ports (e.g., [1, 0, 1, 0]) with a (e.g., one) CQI to signal that the WTRU determined the CSI feedback according to C-JT across ports 1 and 3 of TRP1 and TRP2, respectively.

In examples (e.g., regarding the cases as described herein), a WTRU may report an sTRP assumption for (e.g., multiple) TRPs by reporting a (e.g., one) CQI per PG (e.g., [1, 1, 1, 1] with two CQIs where WTRU computes CQI1 with ports 1 and 2, and CQI2 with ports 3 and 4).

A WTRU may report a W2 including (e.g., consisting of) ports from a (e.g., single) TRP (e.g., [1, 0, 0, 0]) and a (e.g., one) CQI for sTRP hypothesis from TRP1 (e.g., only from TRP1).

A WTRU may receive configuration information indicating (e.g., be configured with) priorities (e.g., different) priorities for (e.g., different) PGs (e.g., a different priority for each PG). A WTRU may omit Type II CSIs from the CSI report (e.g., based on the priority of the different PGs), for example, if (e.g., some, such as a number below or above a threshold) components of the CSI are omitted (e.g., uplink grant for CSI report has insufficient resources to fit all PGs). For example, a WTRU may compute CSI for PG 1 and PG 2, and PG 1 may be determined to have higher priority (e.g., than PG 2). A WTRU may include CSIs for PG 1 (e.g., include CSIs only for PG 1) in the CSI report (e.g., based on the determination that PG 1 has higher priority).

The priority of (e.g., different) PGs may be determined by the WTRU. For example, the priority may be determined based on received signal power (e.g. RSRP) associated with (e.g., two) TRPs. The WTRU may give priority to the highest signal power. For example, the priority may be determined based on a (e.g., preconfigured) priority equation or a ranking as a function of PGs/TRPs. For example, PG 1 may be determined to have higher priority than PG 2.

A WTRU (e.g., with multiple RSGs) may receive configuration information indicating an association between one or more RSGs and a codebook component (e.g., such as a basis matrix). The WTRU may determine to compute and report the CSI using the (e.g., same) codebook components (e.g., spatial or frequency basis) for the one or more TRPs associated to the RSGs. With a (e.g., one) RS with multiple PGs, a WTRU may receive an association between one or more ports/PGs/TCI states to a codebook component (e.g., spatial or frequency basis). A WTRU may determine to compute and report the CSI using the (e.g., same) codebook components (e.g., spatial or frequency basis) for the one or more ports/PGs/TCI states in a (e.g., one) RS. For example, a WTRU may receive configuration information indicating (e.g., be configured with) a (e.g., one) CSI-RS with 4 ports (e.g., where ports 1 and 2 may be configured with PG1 for TRP1, and 3 and 4 with PG2 for TRP2. The WTRU may receive configuration information indicating TCI states 1 and 2 for TRPs 1 and 2, respectively. The WTRU may receive an indication indicating an association between ports 1, 2, 3, and 4, for example, to compute Type II CSI using spatial basis matrix B1 (e.g., if TCI states 1 and 2 are indicated/configured). A WTRU may use the (e.g., same) spatial matrix B1 (e.g. share the spatial matrix) to compute Type II CSI for (e.g., two) different PGs. A WTRU may receive an association between ports 1, 2, 3, and 4, for example, to compute Type II CSI using basis matrix B2 (e.g., if the TCI states are changed to TCI 1 and 3 for TRP1 and TRP3).

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-18. (canceled)

19. A wireless transmit/receive unit (WTRU), comprising:
a processor configured to:
receive multiple transmission/receive point (multi-TRP) channel state information (CSI) reporting configuration information, wherein the multi-TRP CSI reporting configuration information indicates whether to report using basis sharing;
select a first number of beams for a first TRP;
select a second number of beams for a second TRP;
determine a first precoder matrix indicator (PMI) associated with the first TRP based on the first number of beams;
determine a second PMI associated with the second TRP based on the second number of beams;
determine frequency domain basis vector information based on the multi-TRP CSI reporting configuration information, first frequency domain basis vector information associated with the first TRP, and second frequency domain basis vector information associated with the second TRP; and
send a CSI report, wherein the CSI report indicates the first number of beams for the first TRP, the second number of beams for the second TRP, the first PMI, the second PMI, and the frequency domain basis vector information.

20. The WTRU of claim 19, wherein,
on a condition that the multi-TRP CSI reporting configuration information indicates to report using basis sharing, the processor is further configured to:
determine that the first TRP and the second TRP are basis sharing, wherein, based on the determination that the first TRP and the second TRP are basis sharing, the frequency domain basis vector information is shared frequency domain basis vector information associated with the first TRP and the second TRP.

21. The WTRU of claim 19, wherein, on a condition that the multi-TRP CSI reporting configuration information indicates to report without using basis sharing, the frequency domain basis vector information indicates the first frequency domain basis vector information associated with the first TRP and indicates second frequency domain basis vector information associated with the second TRP.

22. The WTRU of claim 19, wherein the multi-TRP CSI reporting configuration information indicates a maximum number of beams per TRP, wherein the first number of beams for the first TRP is below or equal to the maximum number of beams per TRP, and wherein the second number of beams for the second TRP is below or equal to the maximum number of beams per TRP.

23. The WTRU of claim 19, wherein the multi-TRP CSI reporting configuration information indicates a first maximum number of beams associated with the first TRP and indicates a second maximum number of beams associated with the second TRP, wherein the first number of beams associated with the first TRP is below or equal to the first maximum number of beams, and wherein the second number of beams associated with the second TRP is below or equal to the second maximum number of beams.

24. The WTRU of claim 19, wherein the processor is further configured to:
determine a subset of TRPs for report sharing, wherein the subset of TRPs comprises the first TRP and the second TRP, wherein the CSI report further indicates an index associated with the first TRP and the second TRP.

25. The WTRU of claim 19, wherein the multi-TRP CSI reporting configuration information indicates the first TRP and the second TRP.

26. A method, the method comprising:
receiving multiple transmission/receive point (multi-TRP) channel state information (CSI) reporting configuration information, wherein the multi-TRP CSI reporting configuration information indicates whether to report using basis sharing;
selecting a first number of beams for a first TRP;
selecting a second number of beams for a second TRP;
determining a first precoder matrix indicator (PMI) associated with the first TRP based on the first number of beams;
determining a second PMI associated with the second TRP based on the second number of beams;
determining frequency domain basis vector information based on the multi-TRP CSI reporting configuration information, first frequency domain basis vector information associated with the first TRP, and second frequency domain basis vector information associated with the second TRP; and
sending a CSI report, wherein the CSI report indicates the first number of beams for the first TRP, the second number of beams for the second TRP, the first PMI, the second PMI, and the frequency domain basis vector information.

27. The method of claim 26, wherein,
on a condition that the multi-TRP CSI reporting configuration information indicates to report using basis sharing, the method further comprises:
determining that the first TRP and the second TRP are basis sharing, wherein, based on the determination that the first TRP and the second TRP are basis sharing, the frequency domain basis vector information is shared frequency domain basis vector information associated with the first TRP and the second TRP.

28. The method of claim 26, wherein, on a condition that the multi-TRP CSI reporting configuration information indicates to report without using basis sharing, the frequency domain basis vector information indicates the first frequency domain basis vector information associated with the first TRP and indicates second frequency domain basis vector information associated with the second TRP.

29. The method of claim 26, wherein the multi-TRP CSI reporting configuration information indicates a maximum number of beams per TRP, wherein the first number of beams for the first TRP is below or equal to the maximum number of beams per TRP, and wherein the second number of beams for the second TRP is below or equal to the maximum number of beams per TRP.

30. The method of claim 26, wherein the multi-TRP CSI reporting configuration information indicates a first maximum number of beams associated with the first TRP and indicates a second maximum number of beams associated with the second TRP, wherein the first number of beams associated with the first TRP is below or equal to the first maximum number of beams, and wherein the second number of beams associated with the second TRP is below or equal to the second maximum number of beams.

31. The method of claim 26, wherein the method further comprises:
determining a subset of TRPs for report sharing, wherein the subset of TRPs comprises the first TRP and the second TRP, wherein the CSI report further indicates an index associated with the first TRP and the second TRP.

32. The method of claim 26, wherein the multi-TRP CSI reporting configuration information indicates the first TRP and the second TRP.
